(19) United States
(12) Patent Application Publication
(10) Pub. No.: US 2008/0212180 A1
(43) Pub. Date: Sep. 4, 2008

(54) POLARIZATION INDEPENDENT RAMAN IMAGING WITH LIQUID CRYSTAL TUNABLE FILTER

(76) Inventor: Jingyun Zhang, Upper St. Clair, PA (US)

Correspondence Address: CHEMIMAGE CORPORATION, 7301 PENN AVENUE, PITTSBURGH, PA, 15208, US

(21) Appl. No.: 11/681,326

(22) Filed: Mar. 2, 2007

(51) Int. Cl. G02B 27/28

(52) U.S. Cl. 359/502

(57) ABSTRACT

A high passband transmission ratio in microscopic Raman spectral imaging and other applications is obtained by splitting a light beam from an objective lens into two orthogonal polarized components processed along laterally spaced paths through the same liquid crystal tunable filter (LCTF) and imaging lens. At least one of the beams from a polarizing beam splitter is rotated using a wave plate, to cause both beams to be polarized at the nominal plane polarization angle required at the input to the LCTF. Laterally spaced beams emerge from the LCTF to be focused through a same imaging lens, as a single image on a CCD photosensor array. This arrangement ideally achieves 100% transmission in the passband, compared to 50% if the light beam had been coupled directly to the LCTF.

### BACKGROUND

This disclosure concerns apparatus and methods for maximizing the transmission ratio of light during spectrally filtered imaging, especially Raman microscopic imaging using a liquid crystal tunable filter.

A liquid crystal tunable filter or “LCTF” distributes one of two orthogonal polarization components of light over a range of polarization angles as a function of wavelength, and then discriminates for a specific wavelength by transmitting only light having a particular polarization angle. The filter imparts a twist, i.e., an angular rotation of polarization alignment, to a degree that varies with wavelength. Only light at the specific wavelength, that also had a given reference polarization alignment at the input, will emerge with a polarization angle aligned to a polarizing filter that functions as the discriminating element at the output. A liquid crystal tunable filter therefore works only on one of two orthogonal components of input light. The other orthogonal component is blocked. The transmission ratio in the passband is at a maximum if the incident light at the input to the LCTF is aligned to a reference angle of the LCTF and is at minimum if all the incident light energy at the input is orthogonal to that reference angle. If the input light in the passband is randomly polarized, the best possible transmission ratio in the passband is fifty percent.

The present disclosure provides a technique for dual beam processing through the LCTF of both orthogonal polarization components of the incident light at the input to the LCTF so as to maximize the light transmission ratio during spectrally filtered imaging using the LCTF. Furthermore, this is accomplished in a way that facilitates use of the LCTF in an imaging application.

### SUMMARY

According to an aspect of this disclosure, an imaging system is provided with an objective lens, an imaging lens and a spectral filter that relies on polarization alignment, in particular a liquid crystal tunable filter (LCTF). The objective lens collects laser-excited Raman radiation from a sample and directs it as collimated light into a liquid crystal tunable filter, which filter is inherently sensitive to polarization state. Light emerging from the spectral filter is coupled through the imaging lens to be resolved on an image plane such as a charge coupled device (CCD) photosensor array. A polarizing beam splitter is placed ahead of the LCTF along the light transmission path between the objective lens and the imaging lens. The polarization beam splitter separates light from the sample into orthogonal polarization components. At least one of the components is realigned in polarization orientation so that both components are incident on the LCTF spectral filter in the same plane polarized alignment, namely at the reference input alignment of the LCTF.

One polarization component of the light from the sample can be transmitted directly through the polarization beam splitter. This component is plane polarized and incident on the liquid crystal tunable filter (LCTF) at the reference alignment of the LCTF. Therefore, this component is provided at the polarization alignment that obtains a maximum transmission ratio of the passband through the LCTF.

A second polarization component of the light from the sample (the orthogonal polarization component) is diverted by the polarization beam splitter. This second or orthogonal component is redirected as necessary by a reflector and emerges as a plane polarized second beam that also propagates toward the LCTF, but along a path that is laterally offset from the path of the first beam. The polarization alignment of the second beam is altered, prior to the LCTF, to match the reference polarization alignment of the LCTF. In a disclosed embodiment, the diverted beam containing the second polarization component is passed through a half wave plate with fast and slow axes oriented at 45° to the plane polarization angle of the second beam. The half wave plate differentially retards vector components parallel to the fast and slow axes by half a period, i.e., by π radians at a nominal wavelength, thereby rotating the polarization alignment of said second beam by 90°. Upon emerging from the half wave plate, the second polarization component is aligned parallel to the first polarization component, and parallel to the reference input alignment of the LCTF. Therefore, this second component is also incident on the LCTF at the polarization alignment that obtains the maximum transmission ratio of the passband. But the second component propagates along a path that is laterally displaced from that of the first component.

As a result, the light from the sample is coupled to the liquid crystal tunable filter at the reference polarization alignment of the filter but at parallel laterally spaced beam paths. The objective lens can be an infinity corrected objective lens configuration whereby light rays from a given point on the sample are collimated between the objective and imaging lenses. The laterally adjacent beams on paths through the spectral filter are not recombined until after the LCTF. Refraction by the imaging lens assembly focuses the light from any given point on the sample, after arriving through the infinity corrected objective lens and the dual beam spectral filter, and after being limited to the passband wavelength(s) of the LCTF, to a corresponding point on a photosensor array at the image plane.

In this way, a microscopic Raman imaging system or the like, comprising a liquid crystal tunable filter, is made polarization independent while providing an image derived from the sample. And the ideal transmission ratio in the passband is improved from 50% to 100%.

### BRIEF DESCRIPTION OF THE DRAWINGS

There are shown in the drawings certain embodiments that are apt for use in explaining the methods and apparatus presented in this disclosure. However the extent of this disclosure is not limited to these examples but also encompasses variations and other embodiments within the scope of the description and as defined in the claims. In the drawings,

FIG. 1 is a schematic presentation of a polarization independent Raman imaging system with a liquid crystal tunable spectral filter in accordance with one embodiment of this disclosure. Laterally spaced rays of scattered light from a sample subjected to laser light are shown by dashed lines in one polarization state and dash-dot lines in an orthogonal polarization state to show parallel spaced beam paths. The polarization alignment of the light in the paths is shown by double-head arrows, or by dots (representing endwise arrows) where normal to the plane of the sheet.

FIG. 2 is a schematic presentation corresponding to FIG. 1, wherein parallel dash and dash-dot rays from different points at the sample are resolved through said parallel spaced beam paths to distinct points at the image field.

FIG. 3 is an exploded perspective schematic illustration of one embodiment, showing additional aspects discussed in connection with FIGS. 1 and 2.

FIG. 4 is a schematic illustration of an embodiment of a Raman microscopic sample imaging system including aspects of FIGS. 1-3.

### DETAILED DESCRIPTION

There are at least two ways to remove from an optical system certain complications that arise due to polarization state. One can provide two independent optical paths, one for each orthogonal component, or one can split a beam into orthogonal polarization components, realign them relative to one another to assume the same polarization alignment, and rejoin the realigned components at an interference node, back into a single light propagation path.

Normally, beam splitting, realignment and recombination are techniques that may be employed in connection with linear optical paths, to correct for polarization states that may drift over time. The issues are different when considering imaging applications. In an imaging application, each smallest point or pixel amounts to an independent light signal, independent of other pixels. In an imaging application that involves a spectral filter with inherent reliance on polarization orientation, such as a liquid crystal tunable filter, it may be desirable to configure the polarization dependent filter to be polarization independent and also to retain the necessary imaging aspects.

In one embodiment, the disclosure herein exploits the parallel pixel imaging capability of a liquid crystal tunable filter configuration, through which one can resolve an image, and the dual signal path aspect of a scheme for achieving polarization state independence. In another embodiment, the combination of these two approaches is done in a way that is consistent with the inherent polarization state dependence of a liquid crystal tunable filter.

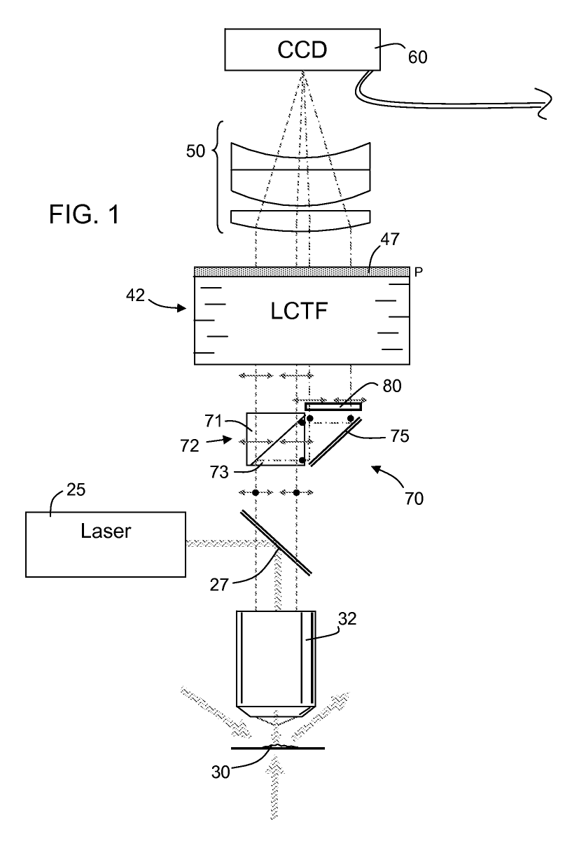

In the embodiment of FIG. 1, an imaging system is provided according to this disclosure, comprising an objective lens 32 operable to collect light from a sample 30 and to provide an image beam. A spectral filter 42 has an input coupled to the image beam. The spectral filter can be a liquid crystal tunable filter but in any event is sensitive to a polarization alignment of light at the input. The filter 42 transmits light to an output in at least one passband as a function of polarization alignment. A photosensitive array 60 at an image plane collects at least one spectrally filtered image of the sample 30.

A polarizer assembly 70 is disposed between the objective lens 32 and the spectral filter 42. The polarizer assembly 70 is operable to separate orthogonal components of the light reflected, emitted, or scattered from the sample 30 into two components, to reorient a polarization alignment of at least one of the components and to apply both said two components to the spectral filter 42 in parallel polarization alignments. In one embodiment, the polarizer assembly 70 may include a polarization beam splitter or polarizing cube 72, a reflector 75, and a half wave plate 80. Detailed discussion of these components of the polarizer assembly 70 and their operation is provided hereinafter.

Light will be transmitted through a liquid crystal tunable filter, provided that the light is at one of the required discrimination wavelengths and has a predetermined polarization alignment relative to the filter. An input polarization beam splitter might be placed immediately precede the filter such that only plane polarized light aligned to the necessary reference input polarization angle is admitted to the filter. However such an input polarization beam splitter is optional because operation of the filter relies on and selects for both the necessary polarization alignment and the necessary wavelength at the input. Thus the filter can only transmit light that is parallel to the input polarization angle anyway.

Therefore, even light that is at the correct wavelength will be blocked by the LCTF if the polarization alignment of that light at the input to the LCTF is orthogonal to the LCTF's predetermined input reference alignment. This has the adverse effect that if the input polarization orientation is random, then the maximum possible transmission ratio of the discrimination wavelengths is 50%.

The present disclosure provides polarization independent embodiments wherein the transmission ratio is substantially improved by parallel processing of originally orthogonal polarization components through a spectral filter that is configured to pass one polarization alignment and to block the orthogonal alignment, in particular an LCTF.

Examples of polarization dependent spectral filters include the Lyot, Evans and Solc birefringent filter configurations, originally developed for astrophysical spectral analysis. Tunable versions have been developed that include liquid crystal elements capable of being adjusted to determine filter bandpass wavelengths. Tunable liquid crystal filters with cascaded stages are disclosed, for example, in U.S. Pat. No. 6,992,809—Wang, et al., the disclosure of which is hereby incorporated by reference. An advantageous application of the liquid crystal tunable filter or “LCTF” is in Raman microscopy, disclosed, for example, in U.S. Pat. No. 6,734,962—Treado, et al.

In an imaging system such as a Raman microscopic imaging system, a sample is subjected to light from a laser. This produces Raman radiation based scattering. The laser may also produce fluorescent radiation due to excitation from the laser light, at an intensity that is much stronger than the desirable Raman signal. It is advantageous to discriminate for the Raman signal. Whereas the Raman signal is relatively weak compared to fluorescence, it is highly desirable not only to discriminate on the basis of wavelength, but also to obtain as high a transmission ratio (for the Raman signal) in the bandpass as possible.

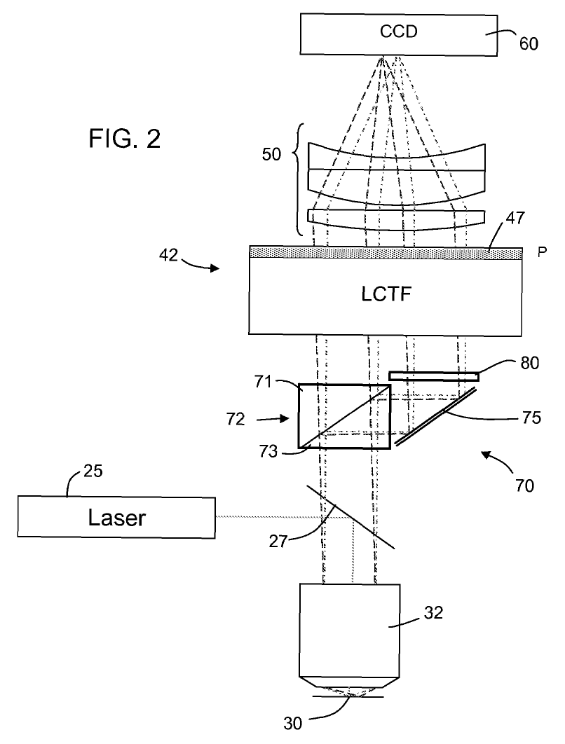

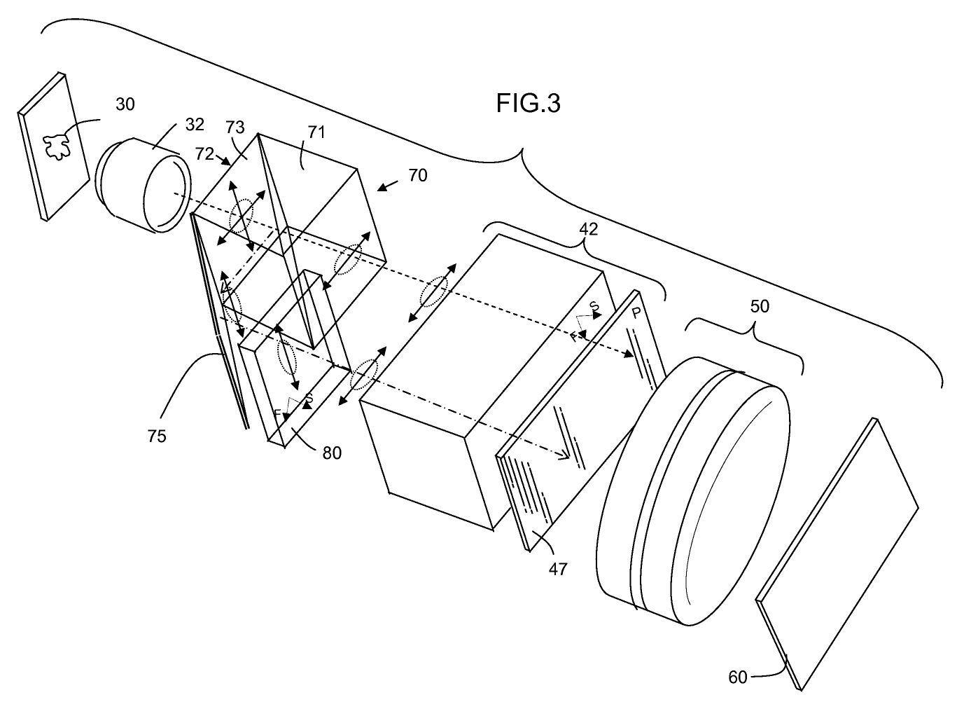

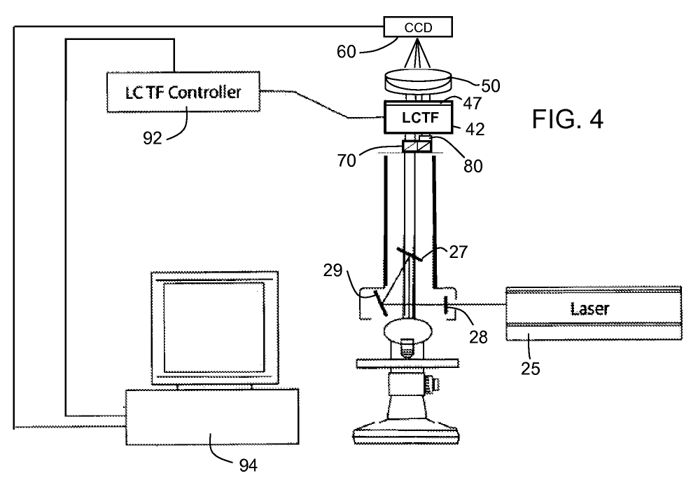

Schematic depictions of the optical elements of the imaging system are shown in exploded elevation views in FIGS. 1 and 2, and in an exploded perspective in FIG. 3. FIG. 4 shows the primary functional elements and shows in a cut-away elevation how the functional elements are embodied in an imaging microscopic system.

Referring now to FIG. 1, the sample, for example on a sample slide carried by a microscope stage, is illuminated by a laser 25. The illumination can be directed along the central axis of an objective lens 32 via a longpass filter 27 in the beam path. In the practical embodiment of FIG. 4, a lens 28 is used to manipulate the laser beam size; and a mirror 29 and longpass filter 27 fold the laser beam path. It is also possible to illuminate the sample from a laser directly in an oblique direction, to excite Raman scattering from the sample, as shown by additional arrows in FIG. 1 representing illumination and resulting reflection, scattering, or emission.

The objective lens 32 collects Raman light from the sample and directs that light by refraction into LCTF 42. The objective lens preferably comprises an infinity corrected objective lens configuration. Accordingly, the sample is disposed at the focal distance from the objective lens 32 and the light rays diverging from any given point on the sample are parallel as the light propagates in a beam parallel to the optical axis of the objective lens 32.

The light beam, comprising parallel rays from each given point on the sample, is directed to the spectral filter 42, which comprises a liquid crystal tunable filter (not shown in detail in FIG. 1). The spectral filter is operated as a bandpass filter. The parallel light rays propagating through the filter 42 are limited by the filter such that only light corresponding to one or more passband wavelengths (in a comb filter transmission characteristic) and of that light only the polarization component that is parallel to the selection polarizer 47 (also labeled “P”) of the LCTF, is transmitted through the LCTF. This light energy remains in a beam of parallel rays. The emerging light is refracted by an imaging lens assembly 50, that directs the parallel rays from each point on the sample to corresponding points on the image plane. The imaging lens assembly can comprise a graded index (GRIN) lens that is associated with the LCTF. The image plane is defined by the surface of a charge coupled device (CCD) array 60, which can be a two dimensional array of photosensors. Each photosensor functions as a light intensity collector for a corresponding pixel position, and the charge collected by exposing the CCD array 60 over a sampling time can be shifted to an analog to digital converter (not shown) and digitized to represent the light intensity at the tuned bandpass wavelength of the filter 42 and at the corresponding pixel position in the image.

By tuning the spectral filter 42 successively to narrow band wavelengths and collecting an image at each band pass wavelength, the system can be operated to collect spatially distributed pixel brightness data for spatially distributed points in the image that is produced according to the disclosed methods and apparatus from the sample subjected to laser light. The spectral filter can be stepped incrementally through a range of spaced bandpass wavelengths or tuned to particular wavelengths known to provide information useful to distinguish among organic or inorganic molecules, biological materials, microbes, etc. In that way it is possible to collect spatially-accurate bandpass wavelength resolved images from the sample. As a group, the images record the spectral emissions of each smallest resolvable area, namely each of the pixels areas defined by discrete cells of the CCD array, over the range of tuned bypass wavelengths.

The liquid crystal tunable filter as described is inherently sensitive to polarization state and operates to transmit only those of incident wavelength(s) that are parallel to one or more selection polarizers 47 placed at one or more points along the propagation path. In one embodiment, the LCTF 42 can comprise cascaded stages, each having a bandpass characteristic controlled by tuning in unison the liquid crystals of the stages. The characteristics of the cascaded stages are superimposed.

Inasmuch as a liquid crystal tunable filter relies on distinguishing between bandpass and bandstop wavelengths as a function of polarization state, the device is inherently polarization dependent. When incorporated in an imaging system involving randomly polarized light, i.e., light with energy in both of two orthogonal polarization components, the filter is limited by its function to pass only one of two orthogonal polarization components, i.e., ideally 50% of the available light at the bandpass wavelength(s).

According to an aspect of the disclosed embodiment, a polarizer assembly 70 is arranged along the beam path at a point prior to propagation of the parallel ray beams from the objective lens 32 to the liquid crystal tunable filter (LCTF) 42. As mentioned hereinbefore, in one embodiment, the polarizer assembly 70 comprises, among other elements, a polarizing cube 72, which may be in the form of a pair of 45° prisms 71, 73 jointly defining a polarization splitting interface surface through which a first orthogonal component of the light is transmitted, and at which the orthogonal second component of the light is reflected laterally or otherwise diverted away from the axis of the objective lens 32.

In FIG. 1, it is assumed that the light from the sample is randomly polarized and the orthogonal polarization components of the light are identified by arrows. A 1^{st} of two orthogonal polarization components is represented by double-headed arrows perpendicular to the direction of propagation, indicating a polarization alignment in the plane of the drawing sheet. The 2^{nd} polarization component (orthogonal to the 1^{st}) is plane polarized in a direction perpendicular to the plane of the drawing sheet and is represented in the drawing by dots (representing arrows seen endwise). Inasmuch as the light from the sample is randomly polarized, both the first and second components (shown as dots and arrows) propagate from the sample toward the polarizing assembly 70. In the example illustrated in FIG. 1, the reference input angle of the LCTF is oriented to the 1^{st} polarization component (the double headed arrows). The polarizing assembly 70 diverts the 2^{nd} polarization component laterally to a reflector 75.

The diverted or 2^{nd} polarization component (also shown in FIG. 1 by dash-dot ray lines) is incident on the reflector 75 in the polarizer assembly 70, which can comprise a surface coated with a dielectric coating, aluminum, silver or the like, for high reflection. The reflector 75 is placed and oriented to divert the orthogonal 2^{nd} polarization component onto a beam path that is parallel to the path of the transmitted 1^{st} polarization component. However the beam path of the 2^{nd} component is now laterally offset by a distance from the beam path of the 1^{st} component, somewhat greater than the width of the beam.

At the reflector 75, the polarization direction of the orthogonal 2^{nd} polarization component remains perpendicular to the polarization direction of the transmitted 1^{st} polarization component (shown as dots). This alignment is perpendicular to the reference input alignment of the LCTF, and would cause the 2^{nd} polarization component to be rejected by the spectral filter 42. Specifically, light in the passband that is orthogonal to the reference input alignment at the input to the LCTF will become perpendicular to the alignment of one or more selection polarizers 47 by operation of the LCTF and will be blocked.

However, according to an aspect of the disclosure, the 2^{nd} polarization is realigned and directed into LCTF 42 at the same alignment as the 1^{st} component, and that alignment is parallel to the reference input alignment of the LCTF. In this embodiment, a half wave plate 80 is disposed along the laterally offset path of the 2^{nd} polarization component. The half wave plate can comprise a birefringent crystal that is oriented with fast and slow axes at 45° to the plane polarization alignment of the 2^{nd} polarization component. The half wave plate has a thickness and a birefringence that produces differential retardation of the component parallel to the slow axis, relative to the component parallel to the fast axis, by π radians. This rotationally reorients or twists the plane polarization state of the 2^{nd} orthogonal polarization component by 90° around the propagation axis, producing a plane polarized state that is parallel to the plane polarization of the transmitted 1^{st} polarization component, shown by double headed arrows in FIG. 1.

Accordingly, the 1^{st} and 2^{nd} polarization components of light from the sample, via the objective lens, are coupled through laterally offset areas of the spectral filter (i.e., the LCTF 42), having been first adjusted such that both polarization components have the same polarization alignment. In particular, in the embodiment of FIG. 1, both beams are plane polarized at an input polarization reference angle for the spectral filter. Typically, that reference angle is 45° to the fast and slow axes of a first birefringent element (not shown) in the LCTF 42, and/or parallel to the polarization alignment of an input polarizer (not shown) in the LCTF structure.

The 1^{st} and 2^{nd} polarization components, now arranged as two parallel plane polarized light beams, propagate through the spectral filter 42 at laterally offset positions. The two beams are coupled to an imaging lens or lens assembly 50, shown in FIG. 1, at laterally offset positions on the lens, such that the imaging lens focuses the rays from a given pixel onto the same pixel position at the image plane. The two polarization components both contribute to the amplitude of the light collected over a sample time interval by the CCD 60.

Provided that the imaging system is properly configured, as described, the total light energy received in the passband of the spectral filter is effectively doubled from the ideal 50% of light energy (e.g., in case of a randomly polarized light having two orthogonal polarization components) in prior techniques that reject one polarization component at the input to the spectral filter, ideally approaching 100% of the available light.

According to an aspect of the apparatus as thus disclosed, at least one of the 1^{st} and 2^{nd} components is re-oriented in polarization alignment so that both components are optimally aligned to the reference input alignment of the LCTF 42. If the LCTF 42 was appropriately aligned, it would also be possible in a different configuration (not shown) to provide elements that reorient both components to correspond to the reference input alignment of the LCTF 42.

As is also apparent from the geometry as shown, the 1^{st} and 2^{nd} components are not simply recombined along the center axis of the LCTF. Instead, in this embodiment, the separate integrity of the two components is maintained as the two components are caused to propagate in the form of independent laterally adjacent beams derived from the respective orthogonal polarization components of the randomly polarized original input light beam as described.

Each of the laterally adjacent beams (the 1^{st} and 2^{nd} components) propagates through the LCTF 42. The LCTF 42 in the depicted embodiment has an available cross sectional size (or aperture) that accommodates the two components as laterally adjacent non-overlapping beams. In FIG. 1, the 1^{st} component beam is delineated by dashed lines and the 2^{nd} component by dash-dot lines. The LCTF 42 is tunable as a unit, and thus selects for one or more predetermined bandpass wavelengths in both the 1^{st} and 2^{nd} component beams. The 1^{st} and 2^{nd} component beams are focused in registry atop one another on the CCD array 60 by an imaging lens assembly 50.

Like the LCTF 42, the imaging lens 50 is sized to admit both of the 1^{st} and 2^{nd} component beams along laterally adjacent beam paths. The 1^{st} and 2^{nd} component beams comprise light energy collected by the same objective lens 32 and thus carry the same image information from the sample 30. Light that was scattered or reflected from any given point on the sample, including light that may have been incorporated in either of the 1^{st} and 2^{nd} component beams, is focused at the same corresponding point on the CCD image array 60. The CCD array comprises an array of photosensitive elements. Each photosensitive element collects a charge representing the light intensity incident on the photosensitive element during a sampling interval. That charge can be digitized to provide a numeric value for a pixel in an image corresponding to the position of the photosensitive element in the CCD array 60.

In practice, there are some additional considerations. In FIG. 1, the delineated beam paths are shown with reference to light from a single point at the center of the sample. FIG. 2 is an illustration corresponding to FIG. 1, but the delineated beams illustrate light associated with two laterally spaced points on the sample. FIG. 3 shows the arrangement of elements but with a simplified illustration of the 1^{st} and 2^{nd} components (shown only by dashed and dash-dot lines representing their respective center axes). Throughout the figures, the same reference numbers are used to depict the same or corresponding element. FIGS. 1-3 each depict the same elements using the same said reference numbers. Therefore, the descriptions of these elements with respect to FIG. 1 is hereby reiterated as to FIGS. 2 and 3.

In FIGS. 1-3, the infinity corrected objective lens 32 is shown as axially symmetrical, i.e., lens 32 has an optical center axis and a field of view. In FIG. 1, the light from a point at the center of the sample propagates in the beam coupled to the polarizer assembly 70 such that all the rays from that center point are parallel to an optical axis of the liquid crystal tunable filter, as described above. As shown in FIG. 2, rays of light from a point on the sample view that is spaced from the center point, although still parallel to one another, are not parallel to the same axis, and are focused to a point on the CCD array 60 that is likewise laterally spaced from the point corresponding to the center point.

Assuming that the LCTF 42 is a rectilinear object as shown in the drawings, propagation of a ray through the LCTF along a line normal to the planar alignment of the LCTF (as in FIG. 1) traverses the minimum thickness of the LCTF. An oblique line of propagation through the LCTF would traverse a relatively greater thickness. This has the effect of detuning the LCTF for oblique rays versus parallel rays. Nevertheless, the LCTF and its polarization independent configuration as per the teachings of the present disclosure (e.g., in the embodiments of FIGS. 1-3) can remain reasonably functional over an angular range of up to about ±3° oblique to the center axis.

Also, in the embodiments shown in FIGS. 1-3, the half wave plate 80 used to rotate the polarization alignment of the 2^{nd} polarization component into alignment with the reference polarization angle of the filter 42 can comprise a fixed retarder optically oriented with fast and slow axes at 45° to the plane polarization angle of the 2^{nd} polarization component (shown as arrows F and S in FIG. 3). The birefringence and thickness of the half wave plate 80 are chosen to produce differential retardation of π radians at a nominal wavelength, for example a midband wavelength of 550 nm. If the spectral filter (e.g., the LCTF 42) is tuned to wavelengths that are near the nominal wavelength, the polarization alignment at the tuned wavelength(s) remains close to parallel with the reference angle of the input to the LCTF and a substantial vector component of the total light energy of the 2^{nd} polarization component is transmitted through the LCTF. The polarizer assembly is shown schematically in the drawings. It should be appreciated that the polarizer (in the illustrated embodiment comprising abutting prisms) and the arrangements for realigning the polarization orientation of one of the two separated orthogonal components (in the illustrated embodiment comprising a half wave plate differential retarder) can be embodied in alternative ways. For example, these elements can be embodied using different types of polarizer, a different sort of orientation changing optical path or the like, provided that the results are as disclosed. Similarly, the elements can comprise discrete components or an assembly of subsets of components or a complete assembly unit.

As shown in FIG. 4, the polarization-independent imaging methodology according to one embodiment of the present disclosure can be incorporated in a Raman imaging microscope having a LCTF that is tuned to selected wavelengths of interest or to a series of wavelengths of interest according to some sequence that results in useful information. The apparatus as described above with respect to its optical elements further comprises a controller 92 for tuning the LCTF 42. The controller 92 is in turn controlled by a computer 94, that may also carry the interface elements coupled to the CCD array 60, and contain a display on which the collected image can be viewed, stored, transmitted over a network, etc.

Light is collected at the CCD photosensor array (not shown) at a substantially improved transmission ratio in the passband, as compared to the alternative wherein light that is orthogonal to the nominal required polarization alignment at the input to the spectral filter is rejected. This improvement in light collection efficiency, ideally can double the transmission ratio in the passband.

Improvement of the passband transmission ratio translates into an improved signal to noise ratio at a given image collection time and illumination power, or to reduction of the required imaging time to collect an image at a given signal to noise ratio. The technique as per the teachings of the present disclosure is applicable to various spectral imaging applications that rely on a specific polarization alignment at the input to a spectral filter. The technique can be used in absorption, fluorescent and Raman imaging, among other examples. Although a laser is suggested as an illumination source or a source of energy exciting secondary radiation from a sample, the light source direction is not critical to operation as described and the type of light source used is dependent on the application.

These benefits are achieved by causing one of two orthogonal polarization components of the light obtained from a sample to be transmitted through a polarizer assembly, and relatively reoriented in polarization alignment therein so that both originally orthogonal components are now parallel and both are aligned to the reference input polarization angle of the liquid crystal tunable filter or LCTF. In the present disclosure, exemplary embodiments use a polarization beam splitter and half wave plate based arrangement that establishes two laterally adjacent beam paths through the LCTF. The spectrally filtered beams containing light energy in the passband are focused on an image plane directly over one another in pixel-to-pixel alignment using an imaging lens system to which the two laterally spaced beams are symmetrically coupled. Therefore, both polarization components of the spectrally filtered collected light in the passband wavelength or wavelengths are efficiently collected and contribute to the intensity signals obtained by the CCD photosensors provided for each pixel at the image plane.

The present subject matter has been described with reference to the foregoing considerations and embodiments that are considered representative as non-limiting examples. Reference should be made to the appended claims, however, in order to assess the scope of the subject matter in which exclusive rights are claimed.

What is claimed is:

1. An imaging system comprising:
an objective lens operable to collect light from a sample and to provide an image beam;
a spectral filter having an input coupled to the image beam, wherein the spectral filter is sensitive to a polarization alignment of light at the input and transmits light to an output in at least one passband as a function of the polarization alignment; and
a polarizer assembly disposed between the objective lens and the spectral filter, wherein the polarizer assembly is operable to separate orthogonal components of the light from the sample into two components, to reorient a polarization alignment of at least one of the components and to apply both said two components to the spectral filter in parallel polarization alignments.

2. The imaging system of claim 1, wherein the spectral filter is configured to transmit the light at a wavelength of said passband which has a polarization alignment parallel to a reference polarization orientation of the spectral filter and to reject light having a polarization orientation orthogonal to the reference polarization orientation of the spectral filter.

3. The imaging system of claim 2, wherein the spectral filter comprises a liquid crystal tunable filter with at least one selection polarizer.

4. The imaging system of claim 3, wherein the reference orientation is 45° to a polarization alignment of an input polarizer of the liquid crystal tunable filter.

5. The imaging system of claim 2, wherein the spectral filter has an aperture encompassing a lateral distance and the polarizer assembly is configured to divert at least one of the two components such that the two components both propagate through said aperture of the spectral filter.

6. The imaging system of claim 5, wherein the polarizer assembly comprises a beam splitter configured to divert at least one of the two components and at least one reflector coupled to at least one of the two components that is diverted by said beam splitter, and wherein the two components are caused to propagate through the aperture of the spectral filter on parallel beam paths.

7. The imaging system of claim 6, further comprising a wave plate along a path of at least one of the components, wherein the wave plate is configured to reorient a polarization alignment of said at least one of the components to correspond to the reference orientation at the spectral filter.

8. The imaging system of claim 6, further comprising:
a photosensitive array at an image plane for collecting at least one spectrally filtered image of the sample; and
an imaging lens between the spectral filter and the photosensitive array, wherein the imaging lens is configured to focus the parallel beam paths such that images of the sample along both beam paths are overlaid on one another at the photosensitive array.

9. The imaging system of claim 8, wherein the imaging lens is at least laterally symmetrical relative to a center line and the parallel beam paths are arranged symmetrically relative to the center line through the imaging lens.

10. The imaging system of claim 8, wherein the imaging lens comprises a graded index (GRIN) lens optically coupled to the spectral filter.

11. The imaging system of claim 5, wherein the polarizer assembly comprises a beam splitter configured to transmit a first of the two components, plane polarized at the reference orientation of the spectral filter, and to divert a second of the two components, plane polarized orthogonal to the reference orientation, to a reflector configured to divert the second component onto a path parallel to and laterally spaced from a path of transmission of the first of the components.

12. The imaging system of claim 11, further comprising a half wave plate along the path of the second component, with fast and slow axes at 45° to a plane polarization of the second component, the half wave plate orienting the second component at a polarization alignment parallel to the reference orientation of the spectral filter.

13. The imaging system of claim 1, configured as a microscopic spectral imaging system and further comprising a source of one of illumination and excitation, and a computer coupled to collect spatially distributed spectral images of the sample.

14. An imaging system having a spectral filter for passing at least one limited spectrum of a light beam from a target, an imaging lens coupled to the spectral filter, and a photosensor array for collecting a spatially distributed image of a sample in at least one spectral band, wherein the improvement comprises:
said spectral filter having an input polarization reference orientation at which light in the spectral band can be transmitted, and light orthogonal to the reference orientation is blocked, said spectral filter defining an aperture;
a polarizer assembly disposed ahead of the spectral filter along a path of the beam from the target, the polarizer assembly being configured to relatively divert at least one of two orthogonal components in the light beam and to transmit light from the two orthogonal components along laterally spaced parallel paths into the aperture of the spectral filter; and
said polarizer assembly comprising at least one wave plate in at least one of the parallel paths, wherein the wave plate is configured to reorient a polarization alignment of at least of the orthogonal components such that the parallel paths into the aperture carry the two orthogonal components having polarization orientations parallel to the reference orientation of the spectral filter.

15. The imaging system of claim 14, wherein the parallel paths through the spectral filter are coupled symmetrically to the imaging lens and the imaging lens is arranged to focus onto the photosensor array spatially corresponding images of the sample from the parallel paths.

16. The imaging system of claim 15, further comprising an infinity corrected objective lens collecting the light beam from the target, wherein the polarizer assembly comprises a polarizing cube for diverting one of the orthogonal components and a reflector directing said one of the components along one of the parallel paths.

17. A method for improving a passband transmission ratio of a spectral imaging filter having a liquid crystal tunable filter sensitive to a polarization orientation of a light input beam from an objective lens to be spectrally filtered and coupled to an imaging lens, comprising:
splitting the input beam into orthogonal polarization components;
diverting at least one of the polarization components laterally from another of the polarization components and adjusting a polarization alignment of at least one of the polarization components to provide two laterally spaced beams both having polarization alignments parallel to a reference input polarization orientation of the liquid crystal tunable filter;
propagating both of the beams through an aperture defined by the liquid crystal tunable filter, along laterally spaced beam paths; and
arranging the imaging lens relative to both laterally spaced beam paths so as to focus images from both of the laterally spaced beams over one another on a same image plane.

18. A polarizer assembly comprising:
an optical beam splitter configured to receive light containing orthogonal polarization components, separate the orthogonal components into two orthogonal components, divert at least one of the two components and allow a non-diverted component to propagate in a propagation direction;
a reflector optically coupled to said beam splitter and configured to receive said at least one diverted component and to reflect the diverted component in the direction parallel to the propagation direction of said non-diverted component; and
a wave plate optically coupled to said reflector and configured to receive said at least one diverted component reflected by said reflector, to reorient a first polarization alignment of said at least one diverted component so as to correspond to a second polarization alignment of said non-diverted component.

19. The polarizer assembly of claim 18, wherein said wave plate is a half wave plate with fast and slow axes at 45° to said first polarization alignment.
